(19) United States
(12) Patent Application Publication
(10) Pub. No.: US 2008/0172621 A1
(43) Pub. Date: Jul. 17, 2008

(54) AUGMENTING SERVICE DESCRIPTION WITH EXPECTED USAGE INFORMATION

(75) Inventors: Danny Soroker, Larchmont, NY (US); Francois Huaulme, New York, NY (US); Chandrasekhar Narayanaswami, Wilton, CT (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/622,322

(22) Filed: Jan. 11, 2007

(51) Int. Cl. G06F 3/01

(52) U.S. Cl. 715/762

(57) ABSTRACT

A system and method for constructing a high-quality interface for interacting with a Web service are provided. The method in one aspect includes specifying a service description to associate with an interface of a Web service in a service description language, specifying expected usage information of the Web service, the expected use information including at least grouping of service operations, probability and relative importance of service operations, and constructing the interface for a client interacting with the Web service based on the service description and the expected usage information. The system in one aspect includes means for performing the method steps.

### FIELD OF THE INVENTION

The present application generally relates to computer systems, and more particularly to user interfaces for service-oriented architecture.

### BACKGROUND OF THE INVENTION

An important aspect of Service Oriented Architecture (SOA) is the capability of describing service interfaces. By having a clean interface description, clients can interact with a service without having to know anything about the internals of the service. This enables various features of SOA such as service composition. Service interfaces are described by standardized languages, most notably the Web Services Description Language—WSDL. Such languages describe operational aspects of the service, such as operation names, parameters and bindings, as well as information documenting the service, such as human-readable descriptions of the various service constituents. This information is important when creating a user interface for a client program interacting with the service. However, it falls short when trying to create high-quality client interfaces.

Known solutions use the WSDL to automatically create a client that essentially lists the service operations. For example, the Web Services Explorer, which is part of the Eclipse Web Tooling Platform project (http://www.eclipse.org/webtools/) automatically creates a browser-based client for interacting with a service based on its WSDL. This client displays the set of service operations as a flat list.

### BRIEF SUMMARY OF THE INVENTION

A system and method for constructing a high-quality interface for interacting with a Web service are provided. The method in one aspect includes specifying a service description to associate with an interface of a Web service in a service description language, specifying expected usage information of the Web service, the expected use information including at least one of grouping of service operations, probabilities and relative importance of service operations, and constructing the interface for a client interacting with the Web service based on the service description and the expected usage information. The system in one aspect includes means for performing the method steps.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating high-level architecture for generating a service interface from the service description in one embodiment of the present invention.

FIG. 2 illustrates at a high level how a programmer uses a service description for creating a user interface for the service in one embodiment of the present invention.

FIG. 3 is a flow diagram of a sample process that employs an enhanced service description in generating a GUI in one embodiment of the present invention.

FIG. 4 shows an example of a screen shot of a service interface generated for a mobile device, where the interface utilizes the device's phone keypad.

### DETAILED DESCRIPTION

A system and method of the present disclosure in one embodiment facilitate creation of high quality user interfaces (UIs) for clients interacting with Web Services. In one embodiment, the system and method augment the service description with information about the expected usage of the service, such as the relative importance of service operations and relationships between operations. By adding such information, a UI created for a client interacting with the service (created either automatically or manually) can be optimized for various usability considerations, such as grouping related operations, and making it easy to invoke common operations.

In one embodiment, the system and method of the present invention augment the service description with expected usage information. The system and method in one embodiment use this information for creating high-quality interfaces for interacting with the service. For example, the following information can be added to the service description:
Grouping of service operations
Probabilities of service operations
Conditional probabilities of service operations
Relative importance of service operations
Mnemonics for operations

The grouping information indicates which operations belong together. This information can be used in various ways, such as to serve as layout hints for a graphical UI (keeping grouped operations physically close) or to serve as grouping information for menus or speech-based interfaces. Groups may be nested, for example, groups may contain other groups.

The probability information can be used, for example, to allocate real estate in a graphical UI (for example, a large button for a common operation) or to help prioritize menu entries and keyboard shortcuts. When the interface is dynamic (for example, a voice-based interface), conditional probability information, such as the likelihood of invoking an operation based on which operation was previously invoked, may be useful. More generally, a Markov process can be associated with the collection of service operations, which can be used to create adaptive interfaces.

The importance information is correlated to probability, but may convey additional information that is not only probability-based. For example, the power on/off operation may not be used that frequently, but may be considered very important.

Mnemonics may be employed to facilitate bindings of operations to hot-keys. For example, a “print” operation may have the mnemonic “p” in the service description, which would cause “<ctrl>-p” to be a shorthand for the print operation in the resultant interface.

Creating a high-quality user interface for interacting with a Web service, either automatically or manually for example, by a programmer, requires an understanding of how the service is to be used. The system and method of the present disclosure in one embodiment encodes such usage information in an augmented service description, which extends the information in the service description language (such as WSDL) by information related to expected usage, such as grouping and importance of service operations.

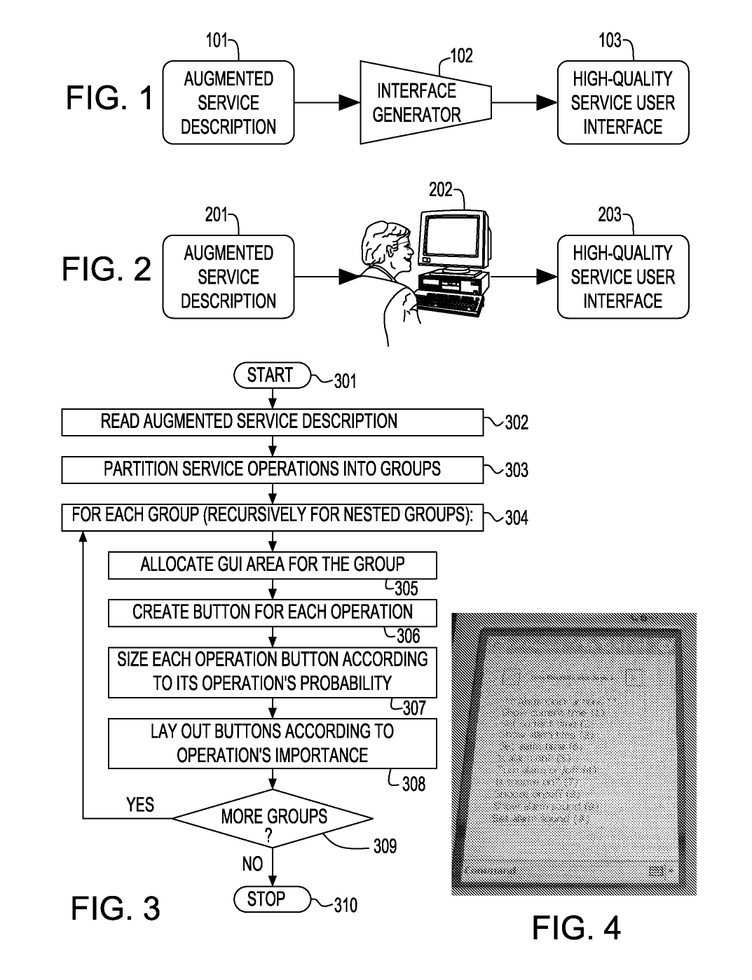

FIG. 1 shows a high-level architecture of a system that generates high-quality user interfaces for services. The augmented service description (101) is provided as input to an interface generator program (102), which generates a high-quality user interface for the service. A user interface can be generated from the standard service description, but an augmented description provides for generating a high-quality user interface.

FIG. 2 shows how a programmer can use the augmented service description. The augmented service description (201) is provided as reference to a programmer (202), who uses it to create a user interface for the service. The service description (201) may be entered into a tool that is used by the programmer (202) for creating the user interface. Having an augmented description enables creation of a better user interface.

FIG. 3 shows an example of a method or algorithm employed by an interface generator (102) in one embodiment of the present invention. In this example, a generator creates a graphic user interface (GUI) with a button for invoking each service operation. The process shown exemplifies how an augmented service description can be employed. After starting (301), the generator reads the augmented service description (302). Next it partitions the service operations to top-level groups (303), as specified in the augmented service description. The following steps are applied to each group, and since groups may be nested, the steps may be applied recursively (304). Step 305 allocates GUI window area (“real estate”) to the group. The amount of area is computed algorithmically, for instance, based on the number of operations in the group and possibly other considerations. Then a button corresponding to each service operation in the group is created (step 306). The button is resized (step 307) according to the corresponding operation's probability. Thus, the relative sizes of the buttons correspond to the expected frequency of their use, so more common operations have larger buttons. Finally, step 308 places the buttons in a way that takes into account their importance. Thus, for example, if an augmented service provides a “power on/off” operation, which is important but may not be frequently used, it would be displayed as a small size button in a conspicuous location. The process continues as long as there are more groups to handle (step 309), after which point it completes (step 310).

The method shown in FIG. 3 describes one of many possibly algorithms that make use of the augmented description in order to generate a higher-quality user interface. Other algorithms may generate non-GUI interfaces, may make use of other elements of an enhanced description (such as mnemonic information), and may affect the generated UI in other ways than just size and placement (such as by use of colors and font). The method illustrates in FIG. 3 shows an example of how one could make use of such augmented information.

FIG. 4 is a screen shot of a user interface for interacting with a service, which was automatically generated using the system and method of the present disclosure. In this example, the user interface runs on a mobile device (PDA), and makes use of its phone keypad. FIG. 4 shows one page of the user interface, which contains the service actions of a particular group (“Alarm Clock” actions). The groups are partitioned into pages, where each page contains at most 12 actions (since there are 12 keys on a phone keypad). The order of actions within a page is related to their frequency. FIG. 4 demonstrates how information in an augmented service description can be translated into elements of a generated user interface.

The following codes show fragments of XML description of a simple service without and with enhancements as described in one embodiment of the present disclosure. The XML description shows part of a complete WSDL specification of this service, for example, elements related to an embodiment of the present disclosure.

XML Description of a Simple Service without Enhancements:

<service>
<action name=“showCurrentTime” returnType=“string”/>
<action name=“setCurrentTime”>
<parameter name=“hour” type=“int”/>
<parameter name=“minute” type=“int”/>
</action>
<action name=“showAlarmTime” returnType=“string”/>
<action name=“setAlarmTime”>
<parameter name=“hour” type=“int”/>
<parameter name=“minute” type=“int”/>
</action>
<action name=“toggleTVPower”/>
<action name=“TVChannelUp”/>
<action name=“TVChannelDown”/>
<action name=“increaseTVVolume”/>
<action name=“decreaseTVVolume”/>
<action name=“toggleTVMute”/>
</service>

The above description shows a simple listing of the service actions, as would be done in a current WSDL specification. The actions may have return types and parameters, as well as other elements, such as descriptions, which are omitted from this example. In this example, the service has 10 actions, 4 of which control an alarm clock, and 6 that control a television. When looking at this description, it is not clear how actions are related to each other, and how common they are.

The following description shows the same service with enhancement in one embodiment of the present disclosure.

XML Description of a Simple Service with Enhancements:

<service>
<group name=“Alarm Clock”>
<action name=“showCurrentTime” returnType=“string” frequency=“40”/>
<action name=“setCurrentTime” frequency=“20”>
<parameter name=“hour” type=“int”/>
<parameter name=“minute” type=“int”/>
</action>
<action name=“showAlarmTime” returnType=“string” frequency=“80”/>
<action name=“setAlarmTime” frequency=“80”>
<parameter name=“hour” type=“int”/>
<parameter name=“minute” type=“int”/>
</action>
</group>
<group name=“Television”>
<action name=“toggleTVPower” frequency=“40”/>
<group name “TV-Channel”>
<action name=“TVChannelUp” frequency=“60”/>
<action name=“TVChannelDown” frequency=“60”/>
</group>
<group name “TV-Volume”>
<action name=“increaseTVVolume” frequency=“80”/>
<action name=“decreaseTVVolume” frequency=“80”/>
<action name=“toggleTVMute” frequency=“40”/>
</group>
</group>
</service>

In the description with enhancements, it is clear that the actions are grouped into 2 groups (“Alarm Clock” actions and “Television” actions), with additional sub-grouping (such as for all TV volume-related actions). In addition, a frequency value is specified for each action, which shows its relative popularity. When comparing the two descriptions above, it is clear that the enhanced description provides additional important hints on how to create a high quality interface for interacting with the service.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for constructing a high-quality interface for interacting with a Web service, comprising:
specifying a service description to associate with an interface of a Web service in a service description language;
specifying expected usage information of the Web service, the expected use information including at least one of grouping of service operations, probability of service operations, relative importance of service operations, and mnemonics for service operations; and
constructing the interface for a client interacting with the Web service based on the service description and the expected usage information.

2. A method of claim 1, wherein the step of constructing is performed automatically by a program executing on a machine.

3. A method of claim 1, wherein the step of constructing is performed manually.

4. A method of claim 1, wherein the expected usage information is specified statically or dynamically based on service usage or combinations thereof.

5. A method of claim 1, wherein the service operations form a hierarchy.

6. A method of claim 1, wherein the probability information includes conditional probabilities.

7. A method of claim 1, wherein the expected usage information is tailored to a user by communicating with a user.

8. A method of claim 7, wherein communicating with a user includes determination of at least one of user's location, age, gender, or other preferences.

9. A system for constructing a high-quality interface for interacting with a Web service, comprising:
means for specifying a service description to associate with an interface of a Web service in a service description language;
means for specifying expected usage information of the Web service, the expected use information including at least one of grouping of service operations, probability and relative importance of service operations; and
means for constructing the interface for a client interacting with the Web service based on the service description and the expected usage information.
